(19) United States
(12) Patent Application Publication
(10) Pub. No.: US 2016/0221091 A1
(43) Pub. Date: Aug. 4, 2016

(54) TURBOMACHINE BLADE RING SEGMENT CUTTING TOOL AND RELATED GUIDE

(71) Applicant: General Electric Company, Schenectady, NY (US)

(72) Inventors: Joshua Michael Oden, Greenville, SC (US); Robert Edward Huth, Greenville, SC (US); Thomas Alan Mogle, II, Simpsonville, SC (US)

(21) Appl. No.: 14/612,865

(22) Filed: Feb. 3, 2015

(51) Int. Cl. B23D 47/02; F01D 25/24; B23D 47/08; F01D 9/04

(52) U.S. Cl. CPC B23D 47/02; F01D 9/042; F01D 25/246; B23D 47/08; F05D 2240/12; F05D 2220/30; F05D 2230/10

(57) ABSTRACT

A cutting tool for cutting a blade mount ring segment from a ring segment slot in a turbomachine casing having a plurality of ring segment slots along an inclined surface is provided. The cutting tool includes a motor; a cutting blade driven by the motor to cut the ring segment; and a support element for supporting the motor. A guide for guiding a cutting tool circumferentially relative to the ring segment includes: a rip fence extending from the support element and including a slide member for slidingly engaging a respective empty ring slot that is axially displaced in the turbomachine casing from the slot in which the ring segment is positioned, and at least one incline compensating member coupled to the support element for slidingly engaging the inclined surface of the turbomachine casing and positioning the support element such that the cutting element of the cutting tool cuts the ring segment.

### BACKGROUND OF THE INVENTION

The disclosure relates generally to turbomachine maintenance, and more particularly, to a turbomachine blade ring segment cutting tool and a related guide.

Industrial turbomachines include a series of stator vanes that include stationary blades extending from an outer casing interposed with a plurality of moving blades coupled to a rotor that act to move/compress a working fluid or be moved by a working fluid. One illustrative turbomachine includes a compressor, which are used widely to provide a compressed fluid for, for example, combustion in a combustor of a gas turbine. As any industrial machine, turbomachines require periodic maintenance.

One time consuming maintenance process is replacing the blades such as stator vanes from a turbomachine like a compressor. In particular, certain stages of a turbomachine may include stator blades that are mounted to one or more ring segments that are mounted in a slot in the turbomachine casing. Each ring segment includes a number of blades, and collectively a set of ring segments can create a complete ring of radially extending blades. Oftentimes these ring segments are extremely difficult to remove from the slots of the casing. One approach to remove the ring segments includes cutting the blades off of the ring segments, and exposing the ring segments to a grinding tool or arc gouging process to cut/destroy the ring segments so they may be collapsed and removed from the slots. Arc gouging includes creating an electric arc between a tip of an electrode, e.g., a carbon electrode, and a target workpiece. As the arc is applied, the metal becomes molten and an air jet stream applied along the electrode pushes the molten metal away, thus leaving a groove in the target workpiece. The grinding tool creates a similar groove through grinding. The grinding approach and arc gouging approach are both time consuming and may cause damage to the turbomachine casing if the tool's work element passes through the ring segment to the casing. In addition, cutting of the ring segment may still require application of force from peening guns, hydraulic rams, etc., to ensure removal.

Another approach to removing the ring segments employs a circular saw mounted to a large bridge that spans the turbomachine casing and a mechanism, including pulleys and a motor, to pivot the cutting wheel of the saw about a center point of the casing. After the stator blades are removed from the ring segments, the circular saw cuts a kerf into the remaining ring such that the ring segments can be removed. The bridge is positioned by fixation to the horizontal joint of the casing, and is a very complicated structure.

### BRIEF DESCRIPTION OF THE INVENTION

A first aspect of the disclosure provides a cutting tool for cutting a blade mount ring segment from a ring segment slot in a turbomachine casing having a plurality of ring segment slots along an inclined surface, the cutting tool comprising: a motor; a cutting blade driven by the motor to cut the ring segment; a support element for supporting the motor; a guide for guiding the tool circumferentially relative to the ring segment, the guide including: a rip fence extending from the support element and including a slide member for slidingly engaging a respective empty ring slot that is axially displaced in the turbomachine casing from the slot in which the ring segment is positioned, and at least one incline compensating member coupled to the support element for slidingly engaging the inclined surface of the turbomachine casing and positioning the support element such that the cutting blade cuts the ring segment.

A second aspect of the disclosure provides a guide for circumferentially guiding a cutting tool for cutting a blade mount ring segment from a ring segment slot in a turbomachine casing having a plurality of ring segment slots along an inclined surface, the cutting tool including a support element for supporting a cutting element of the cutting tool, the guide including: a rip fence extending from the support element and including a slide member for slidingly engaging a respective empty ring slot that is axially displaced in the turbomachine casing from the slot in which the ring segment is positioned; and at least one incline compensating member coupled to the support element for slidingly engaging the inclined surface of the turbomachine casing and positioning the support element such that the cutting element cuts the ring segment.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a cross-sectional view of a turbomachine casing including a cutting tool and guide according to embodiments of the invention.

FIG. 2 shows a perspective, lower frontal view of a cutting tool and guide according to embodiments of the invention.

FIG. 3 shows a perspective, upper rear view of a cutting tool and guide according to embodiments of the invention.

FIG. 4 shows a perspective view of the cutting tool and guide of FIGS. 2-3 in position for cutting a ring segment on a turbomachine casing.

FIG. 5 shows a front view of the cutting tool and guide of FIGS. 2-3 in position for cutting a first ring segment in an inclined surface on a turbomachine casing.

FIG. 6 shows a front view of the cutting tool and guide of FIGS. 2-3 in position for cutting a ring segment in the middle of an inclined surface on a turbomachine casing.

FIG. 7 shows a perspective view of an alternative cutting tool with the guide of FIGS. 2-3 in position for cutting a ring segment on a turbomachine casing.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, the disclosure provides a cutting tool for cutting a blade mount ring segment from a ring segment slot in a turbomachine casing having a plurality of ring segment slots along an inclined surface. In addition, a guide for a cutting tool is provided.

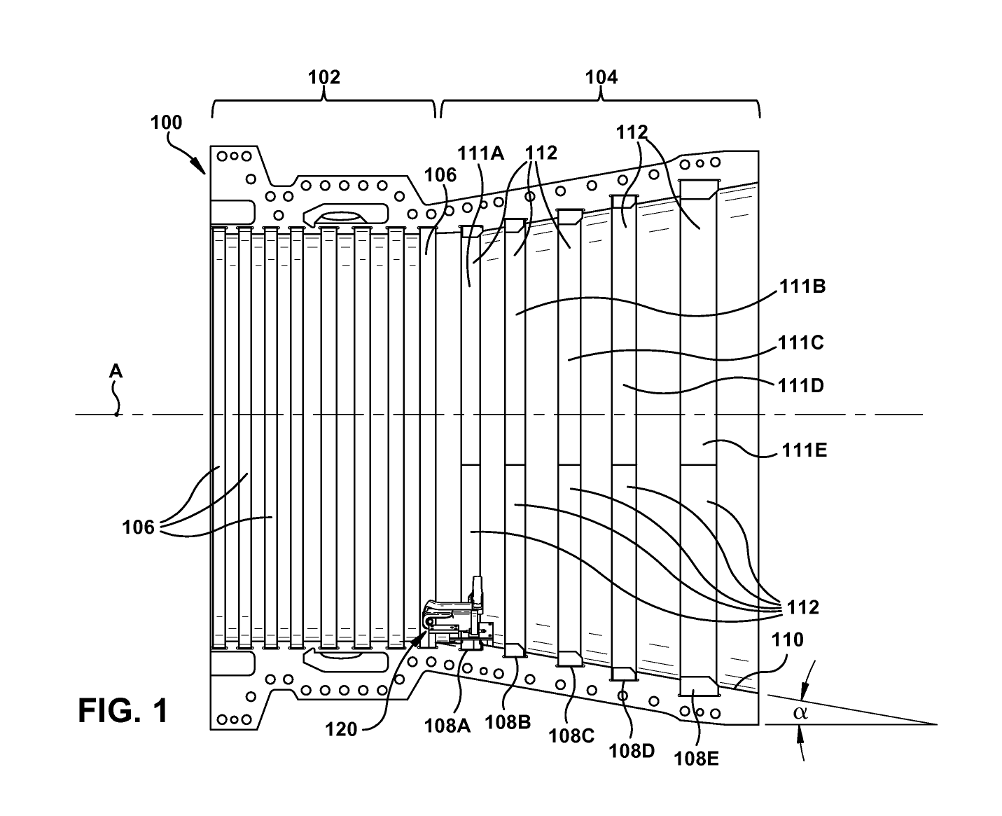

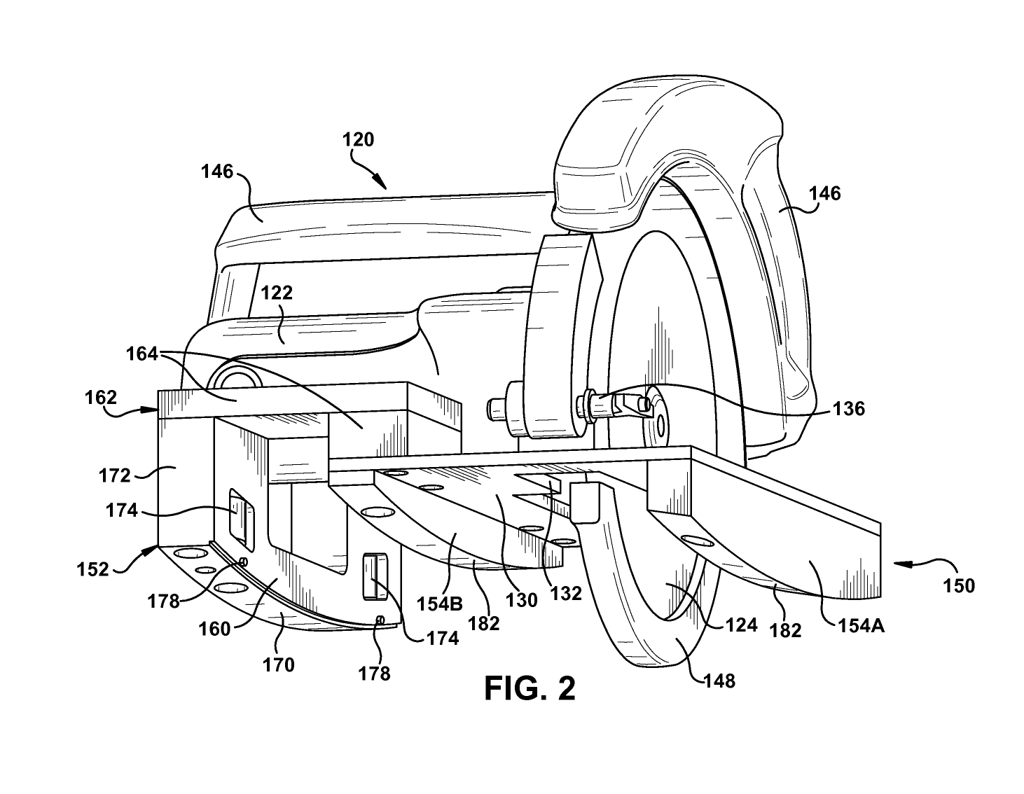

Referring to the drawings, FIG. 1 shows a turbomachine casing 100 in a state of maintenance in which a cutting tool 120 and a related guide 150 (FIG. 2) according to embodiments of the invention may be employed. In this setting, the turbomachine rotor has been removed. Turbomachine casing 100 can be part of a large variety of turbomachines, e.g., steam turbine, gas turbine, compressor, etc In the example shown, turbomachine casing 100 is a compressor half-shell. In the example shown, turbomachine casing 100 (hereinafter “casing 100”) includes a linear section 102 and an integral frusto-conical section 104. Linear section 102 includes a plurality of slots 106 that extend circumferentially about an interior surface of section 102. Each slot 106 receives a series of circumferentially arranged individual blades (not shown, removed). In contrast, frusto-conical section 104 includes a plurality of blade mount ring segment slots 108A-E that extend circumferentially about an interior surface 110 of section 104. As indicated, interior surface 110 (hereafter “inclined surface 110”) is inclined to accommodate sequentially decreasing sized blade stages of the turbomachine. An axial internal angle α of inclined surface 110 of the turbomachine casing can vary depending on the type of turbomachine, number of stages, size of blades, etc.

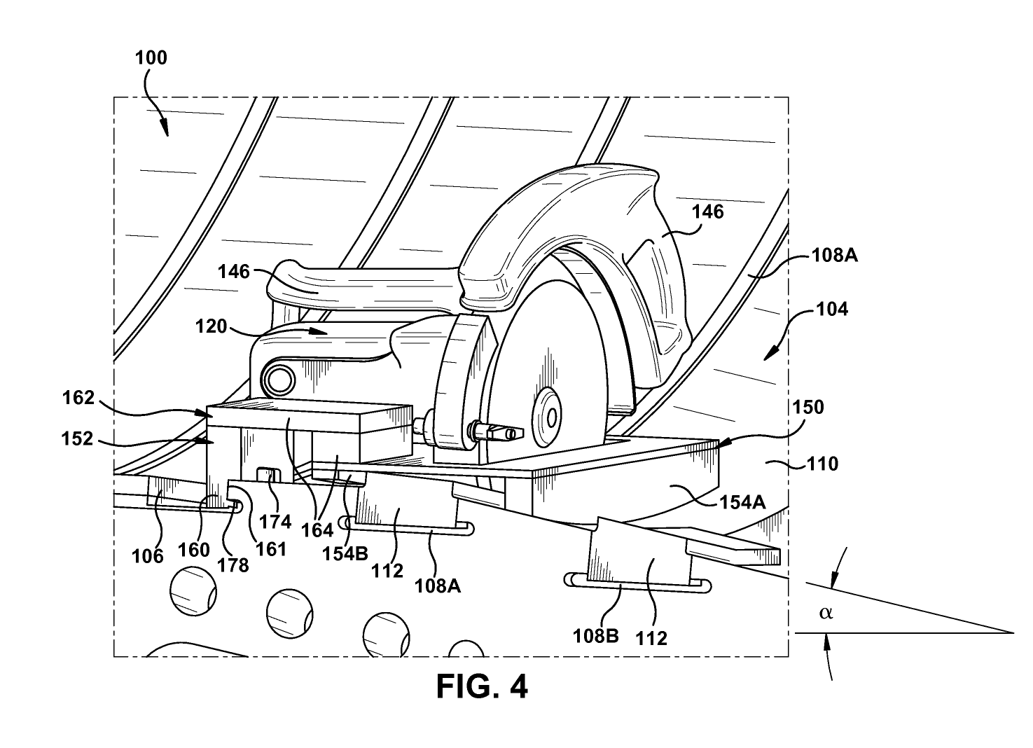

Blade mount rings 111A-E are each formed of a number segments 112 seated in each slot 108A-E. Each ring segment 112 may extend circumferentially a portion of the circumference, e.g., 60°, 45°, 30°, of casing 100. Each ring segment 112 typically includes a number of integral, circumferentially spaced stationary blades extending radially therefrom (not shown) toward an axis A of casing 100. Sets of corresponding, rotating, rotor blades would extend from a rotor (removed) between the sets of stationary blades, forming the various stages of the compressor in section 104. With the blades in place, a number of ring segments 112 can be used within each slot 108A-E to provide equally spaced blades about an axis A of casing 100 and to form rings 111A-E. At the illustrated stage of maintenance, however, the blades have been cut from rings 111A-E and ground down, leaving just ring segments 112 in respective slots 108A-E, perhaps with some remnants of the blades (see FIG. 4). Cutting tool 120 may cut all or any number of ring segments 112 from a given slot 108A-E, depending on what is necessary to remove rings 111A-111E.

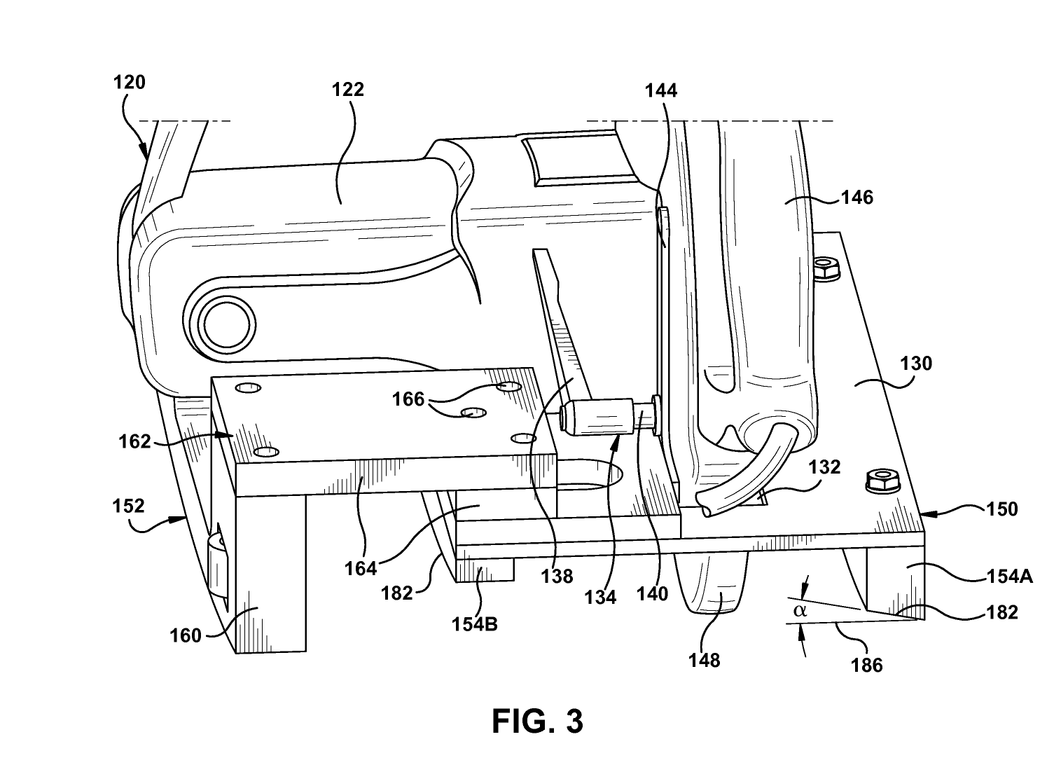

Referring to FIGS. 2-4, details of cutting tool 120 and guide 150 will now be described. FIG. 2 shows a perspective, lower frontal view of cutting tool 120 with guide 150; FIG. 3 shows a perspective, upper rear view of cutting tool 120 with guide 150; and FIG. 4 shows an enlarged perspective view of cutting tool 120 with guide 150 in position for cutting a ring segment 112 in a slot 108A on casing 100, and in particular, frusto-conical section 104.

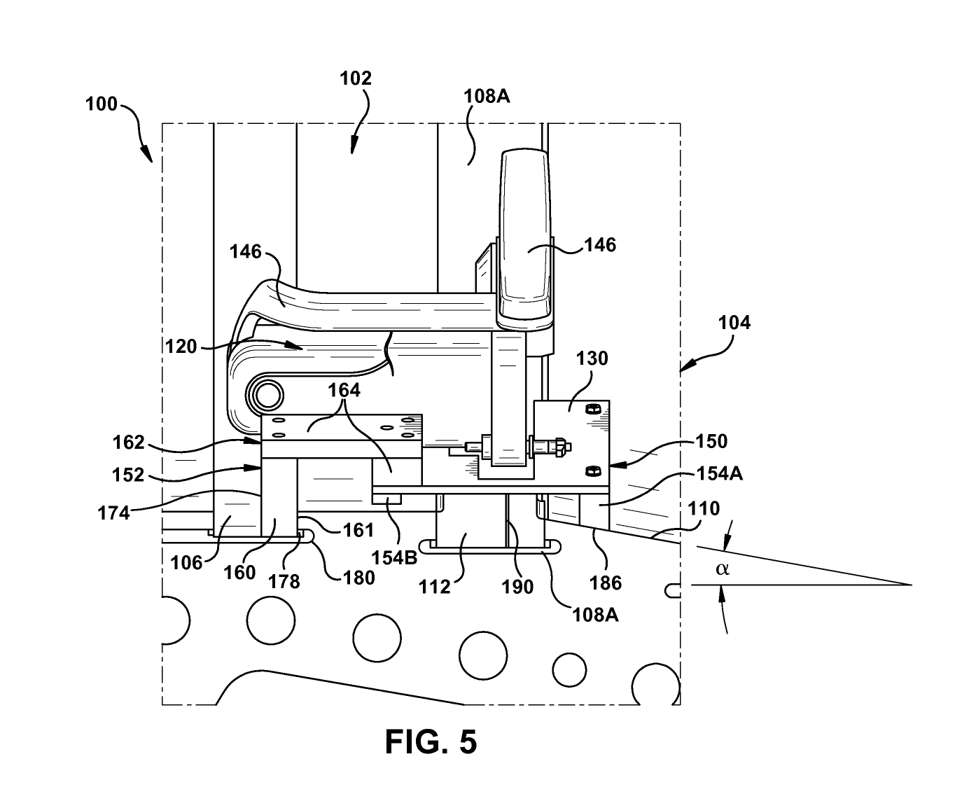

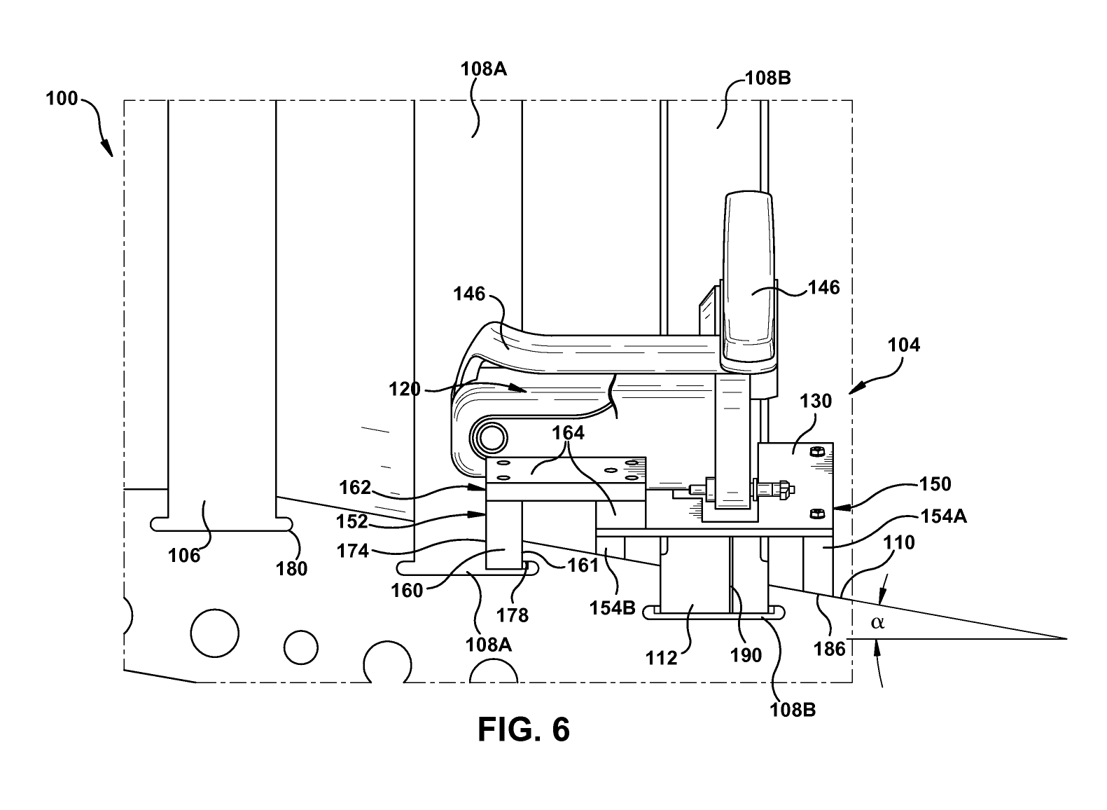

As shown in FIGS. 2-4, in one embodiment, cutting tool 120 is provided as any now known or later developed circular saw capable of cutting ring segments 112, e.g., a Steelmax® brand metal cutting circular saw or similar commercially available circular saw. To this end, cutting tool 120 may include a motor 122 for rotatably driving a cutting element 124 in the form of a cutting blade to cut ring segment 112. Motor 122 may include any now known or later developed form of rotary power, e.g., hydraulic, electric, pneumatic, etc. The cutting blade may include any now known or later developed rotary cutting blade capable of cutting the material of ring segments 112. The cutting blade may also include any special cutting features, e.g., carbon tips, etc., required, and may have any diameter necessary to ensure non-binding cutting. It is emphasized that while embodiments of the invention are illustrated with cutting tool 120 as a circular saw, guide 150 may also be applied to a wide variety of other cutting tools with other forms of cutting elements, e.g., grinding wheel, cutting torch, arc gouging electrode, laser cutting tool, etc. Regardless of the type of cutting tool or cutting element, as will be described, cutting element 124 may create a kerf 190 (FIGS. 5-6) in ring segment 112 with a width sufficient to remove a sufficient amount of ring element 112 such that remaining portions of the ring segment can be radially removed from a respective slot 108A-E, as will be described herein. The size of the kerf may be user defined depending on various features of ring segment 112, e.g., material flexibility, width, etc.

Regardless of the type of cutting element employed, cutting tool 120 also includes a support element 130 for supporting the cutting element. In terms of a circular saw, support element 130 supports, among other things, motor 122 and cutting element 124. In the example shown, support element 130 may take the form of a rigid plate, e.g., a metal plate. However, as will be apparent, support element 130 need to be a plate or planar. Support element 130 may be part of a conventional circular saw and modified to accommodate guide 150, or constructed as a separate part that forms part of the guide. In the circular saw example, cutting element 124 extends through an opening 132 in support element 130, in a conventional manner.

As shown in FIG. 3, where cutting tool 120 includes a mechanical cutting element 124 such as a cutting blade, cutting tool may include an optional cutting depth adjuster 134 for selectively controlling an extent to which cutting element 124 extends from support element 130. In the embodiment shown, a front mount 136 (FIG. 2) of cutting tool 120 includes a pivot that allows motor 122 and cutting element 124 to pivotally move relative to plate 130, altering an extent to which cutting element 124 extends from support element 130. As shown in FIG. 3, cutting depth adjuster 134 may include a knob 138 capable of clamping a position of motor 122 and cutting element 124 relative to support element 130. Knob 138 may include a threaded fastener 140, e.g., a nut, that tightens onto a bolt (within knob 138) that is coupled to motor 122, i.e., a housing therefor, and rides in a curved guide slot 144 affixed to support element 130. Rotation of knob 138 tightens the nut and bolt together, clamping the pivotal position of motor 122 relative to support element 130 and hence the extent to which cutting element 124 extends from opening 132 in support element 130. While one form of cutting depth adjuster 134 has been illustrated, it is emphasized that a large variety of other known or later developed cutting depth adjusters may also be employed. Further, where cutting element 124 includes a mechanism capable of electronic depth control (e.g., cutting torch, etc.), cutting depth adjuster 134 may be omitted. Cutting tool 120 may also optionally include any other now known or later developed ancillary structures for a power tool such as but not limited to: one or more handles 146, a movable cutting element shroud 148, alignment indicia, safety features such as automatic shutoff and two-points-of-contact operating switches, bevel adjustment, variable speed and power settings, vibration isolators, power supply cords/hoses, etc.

With continuing reference to FIGS. 2-4, a guide 150 for guiding cutting tool 120 circumferentially relative to ring segments 112 is also illustrated. Guide 150 may include a rip fence 152 and at least one incline compensating member 154A, 154B. Collectively, rip fence 152 and incline compensating member(s) 154A, 154B position cutting element 124 to cut ring segments 112 in a particular slot 108A-E by allowing controlled circumferential sliding of cutting tool 120 relative to the ring segment. More particularly, rip fence 152 axially positions cutting element 124 such that it can maintain its axial position by slidingly engaging an already empty slot in casing 100. Further, incline compensating member(s) 154A, 154B slidingly engage inclined surface 110 to angularly maintain the position of cutting element 124 to cut ring elements 112.

As illustrated in FIGS. 2-4, rip fence 152 may extend from support element 130 and include a slide member 160. As used herein, “axial” refers to the direction of axis A of casing 100, and “radial” refers to a direction substantially perpendicular to axis A. Hence, rip fence 152 may extend axially from support element 130 relative to casing 100, and cutting element 124 extends substantially radially relative to casing 100. As shown in FIG. 4, slide member 160 is configured for slidingly engaging a respective empty ring slot 106, 108 (106 as shown) that is axially displaced in turbomachine casing 100 from the slot (108A as shown) in which a ring segment 112 to be cut is positioned. As will be described, as ring segments 112 are removed, those slots 108A-E from which the segments are removed can be used as the empty slots in which slide member 160 moves for cutting of a subsequent ring segment. Rip fence 152 may further include an adjustable arm 162 supporting slide member 160. As illustrated, adjustable arm 162 may include a number of members 164 shaped and sized to position slide member 160 at an appropriate distance from cutting element 124 to position cutting element 124 to cut ring segment 112. Slide member 160 and members 164 may be arranged to extend up and over structures in casing 100, if necessary. Adjustable arm 162 couples to support element 130 and may be configured to adjustably change the distance of slide member 160 from cutting element 124 in any number of ways. As shown in FIG. 3, members 164 may be selectively coupled to support element 130 at any of a number of predefined lateral positions by way of a number of fasteners 166 that couple to support element 130, e.g., threaded fasteners that thread into support element 130. Although one form of adjustable arm 162 has been illustrated, it is emphasized that a large number of alternative length-adjustable arm structures exist and may be employed and are considered within the scope of the invention. For example, length adjustable arms may come in form of, e.g., selectively positionable telescopic members, selectively positionable sliding members, etc. Adjustable arm 162 may be made of any material having sufficient rigidity and strength to withstand the function of motor 122 and cutting element 124, e.g., steel. A set of adjustable arms 162 may be provided having differently length ranges to accommodate different casings, e.g., with different spacing between slots 106, 108, different sized slots, different sized ring segments, etc.

Referring to FIG. 2, slide member 160 is illustrated from a lower position. Slide member 160 is affixed to or formed as part of adjustable arm 162, e.g., using any conventional fastening mechanism such as threaded fasteners, welding, uniform construction, etc. As shown, slide member 160 may include a number of features to ensure it maintains sliding contact with an empty slot 106, 108 in casing 100. In particular, slide member 160 may include a number of features to maintain sliding engagement with an axially facing surface 161 (FIGS. 4-6) of a respective empty slot 106, 108 in which slide member 160 is slidingly engaged such that cutting element 124 maintains a desired axial position relative to a ring segment 112 to be cut.

In one embodiment, shown in FIG. 2, slide member 160 may include a curved casing engaging surface 170 configured to substantially mate with a circumferential arc of inclined surface 110 of casing 100 in empty ring slot 106, 108. That is, surface 170 has a curvature that substantially matches that of casing 100. Slide member 160 may be made of any material having sufficient strength and sliding ability to withstand prolonged sliding engagement with inclined surface 110 of casing 100, e.g., a metal such as steel or aluminum, a hard plastic such as nylon or polytetrafluoroethylene (PTFE) or other similar materials. In one embodiment, all of slide member 160 may include a metal such as steel or aluminum. In another embodiment, however, a body 172 of slide member 160 may include a metal such as steel, and curved casing engaging surface 170 may include a hard plastic such as PTFE. In this latter case, surface 170 may be constructed so as to be replaceable, e.g., with fasteners or other coupling mechanisms to body 172.

Slide member 160 may also include one or more roller bearings 174 for rollingly engaging axially facing surface 161 (FIG. 4-6) of empty ring slot 106 (as shown), 108. Roller bearing(s) 174 may be substantially vertically oriented in body 172, and may be made of a metal, e.g., steel, or hard plastic such as PTFE. Alternatively, bearings 174 may be angled so as to substantially match a radius of casing 100. As shown in FIG. 2, slide member 160 may also further include a retaining member 178 for engaging a circumferential groove 180 (FIGS. 5-6) in empty ring slot (106 in FIG. 5, 108B in FIG. 6) to slidingly retain the slide member in the empty ring slot. More particularly, as shown in FIGS. 5-6, each groove 106, 108 includes a circumferential groove 180 that extends circumferentially therealong on both sides thereof at a radially outward end thereof. Retaining member 178 extends from body 172 in a position such that it may engage with circumferential groove 180 and slide therealong to retain slide member radially in empty slot 106. As illustrated, in one embodiment, retaining member 178 includes a number of axially protruding pins extending from body 172 of slide member 160 to engage an underside of groove 180. It is understood, however, that retaining member 178 may include a wide variety of alternative structures that may provide the same function, e.g., more or less pins, a curved rib, etc. A set of slide members 160 may be provided having differently arced, casing engaging surfaces 170, a differently positioned retaining member 178, differently positioned or sized bearings 174, etc., to accommodate different casings, e.g., with different diameters, different curvatures, different sized slots, different sized ring segments, different spacing between slots, etc.

Referring to FIGS. 4-6, incline compensating member(s) 154A, 154B may be coupled to support element 130 for slidingly engaging inclined surface 110 of casing 100 and positioning support element 130 such that cutting element 124 (e.g., blade) of cutting tool 120 cuts ring segment 112. Any number of incline compensating members 154 may be employed, and each member may extend a different distance from support element 130 to slidingly engage inclined surface 110 of casing 100. In one embodiment, a pair of incline compensating members 154A, 154B may be employed, one to each side of cutting element 124 and each slidingly engaging a different portion of inclined surface 110. More or less members 154 may be employed, if desired. As shown best in FIG. 5, each incline compensating member 154 is sized to extend from support element 130 a generally radial distance sufficient to maintain a position of support element 130 relative to inclined surface 110, i.e., based on where the particular member is axially positioned on support element 130. In the embodiments shown, each incline compensating member 154 has a radial length to maintain support element 130 substantially parallel with an axis A (FIG. 1) of casing 100. In this manner, as shown in FIG. 5, assuming cutting element 124 is positioned substantially perpendicular to support element 130, the cutting element will cut ring element 112 in a substantially vertical direction. It is emphasized that a substantially vertical cut is not necessary in all cases, and cutting tool 120 may be employed with incline compensating members 154 that do not position support element 130 substantially parallel to axis A (FIG. 1). Further, assuming support element 130 is positioned substantially parallel to axis A (FIG. 1), cutting element 124 may be angled relative to support element 130, e.g., by use of a conventional bevel adjustment on a circular saw.

As shown best in FIGS. 2 and 3, each incline compensating member 154A, 154B may include a curved casing engaging surface 182 configured to substantially mate with a circumferential arc of internal surface 110 of casing 100. Surface 182 allows incline compensating member(s) 154A, 154B to slidingly support cutting tool 120 relative to inclined surface 110 as it is moved circumferentially as it cuts ring element 112 in a uniform and safe manner. Each incline compensating member 154 may be made of any material having sufficient strength and sliding ability to withstand prolonged sliding engagement with interior surface 110 of casing 100, e.g., a metal such as steel, or a hard plastic such as nylon or PTFE. In one embodiment, each incline compensating member 154 may include steel. In another embodiment, however, similar to slide member 160, a body of each member 154 may include a metal such as steel, and curved casing engaging surface 182 may include a hard plastic such as PTFE. In this latter case, surface 182 may be constructed so as to be replaceable, e.g., with fasteners or other coupling mechanisms to the body.

With reference to FIGS. 3 and 5, and as shown best in FIG. 3, one or more curved casing engaging surface(s) 182 of incline compensating member(s) 154A, 154B may also include an axial bevel 186 configured to substantially mate with an axial internal angle α of inclined surface 110 of casing 100. Axial bevel 186 also allows incline compensating member(s) 154A, 154B to slidingly support cutting tool 120 relative to inclined surface 110 as it is moved circumferentially as it cuts ring element 110 in a uniform and safe manner. In one embodiment, for a particular casing 100 or for a set of casings 100, a set of incline compensating members 154 may be provided to accommodate each ring element 112 regardless of which slot 108A-E the ring segment is positioned. The set of compensating members 154 may have members with different curvatures of surface 182, different bevel angles 186, different lengths, etc. In any event, as observed by comparing FIGS. 5 and 6, each incline compensating member 154 would be configured for selective coupling to support element 130, e.g., with threaded fasteners. Each compensating member 154 could be beveled to accommodate supporting support element 130 at a desired angle relative to axis A (FIG. 1) of casing 100, e.g., substantially parallel, regardless of the slot 108A-E in which the ring segment 112 to be cut is positioned.

Turning to FIGS. 5 and 6, operation of cutting tool 120 is illustrated. In FIG. 5, cutting tool 120 is positioned for cutting a ring element 112 that is in a first ring segment slot 108A adjacent to linear section 102 of casing 100. This is the same scenario shown in FIGS. 1-4. Here, slide member 160 of rip fence 152 is positioned in a slot 106 closest to frusto-conical section 104 and adjacent ring segment slot 108A of casing 100 such that cutting element 124 is positioned to cut ring segment 112 in slot 108A. In this position, incline compensating member 154A is in contact with inclined surface 110 and thus includes a bevel 186, while member 154B is in contact with linear section 102 of casing 100, and does not require a bevel. In contrast in FIG. 6, cutting tool 120 is positioned for cutting a ring element 112 that is in a ring segment slot 108C that is in the middle of frusto-conical section 104 of casing 100. Here, slide member 160 of rip fence 152 is positioned in a slot 108B closest to and adjacent ring segment slot 108C of casing 100 such that cutting element 124 is positioned to cut ring segment 112 in slot 108C. Any ring segment that was in slot 108B that would prevent movement of cutting tool 120 to cut the ring element in slot 108C has already been removed. In this position, both incline compensating members 154A, 154B are in contact with inclined surface 110, and both include a bevel 186 to substantially match with inclined surface 110.

In either of the positions shown in FIG. 5 or 6, cutting tool 120 is initially powered on by turning motor 122 on to rotate cutting element 124. As cutting element 124 turns, cutting tool 120 is aligned such that rip fence 152, and in particular slide member 160 engages in a respective empty slot (106 in FIG. 5, 108B in FIG. 6). Cutting element 124 may be initially plunged into ring segment 112 to make an initial cut in this position, e.g., where cutting element 124 includes a cutting blade. A depth of cut of cutting element 124 can be adjusted by cutting depth adjuster 134 (FIG. 3) or other depth adjusting mechanism, if provided. The depth of cut can be user defined to cut as deep into ring segment 112 as desired. Typically, cutting element 124 is set such that it cuts through all or most of ring segment 112 but ideally does not penetrate into casing 100, thus preventing damage to casing 100. Where material remains in the bottom of kerf 190, it can be manually removed, allowing remaining portions of ring segment 112 to collapse into kerf 190 and thus allow removal thereof. As cutting element 124 initially cuts into ring segment 112, slide member 160 is brought into contact with axially facing surface 161, which axially positions cutting element 124 relative to ring segment 112. Additionally, retaining member(s) 178, where provided, may seat in groove 180, radially retaining slide member 160 in empty slot 106, 108, and roller bearings 174 engage axially facing surface 161 of the empty slot. (It is noted that while casing 100 has been illustrated in a horizontal position, it may also be arranged in a vertical fashion. In this case, retaining member(s) 178 may also function to prevent cutting tool 120 from falling out of the empty slot 106, 108 as cutting tool 120 is moved horizontally within ring segments 112 as it cuts.) Cutting element 124 is ideally positioned near an axial middle of ring segment 112, but that is not necessary in all instances. Once the initial cut is made, cutting tool 120 may be moved circumferentially relative to casing 100 such that slide member 160 of rip fence 152 slidingly engages axially facing surface 161, i.e., with roller bearing 174, of the empty ring slot, maintaining a desired axial location of cutting element 124 in ring segment 112. As cutting tool 120 is moved circumferentially, incline compensating member(s) 154 maintains a radial position of cutting tool relative to casing, e.g., maintains support element 130 substantially parallel to axis A (FIG. 1). Cutting tool 120 progressively cuts ring segment 112 as it is moved circumferentially. Each ring 111A-E (FIG. 1) may be cut in one full circumferential movement of cutting tool 120, or one or more segments 112 of a ring 111A-E may be cut individually. In any event, once each ring segment 112 is cut, the ring segment includes a kerf 190 (FIGS. 5 and 6) of sufficient axial width that the remaining portions of ring segment 112 can be readily removed from the respective slot. That is, cutting element 124 may have a kerf width sufficient to remove a sufficient amount of a ring element 112 such that remaining portions of the ring segment can radially removed from a respective slot 108A-E. Each remaining portion of a ring segment 112 may be removed in a number of ways. For example, the remaining portions may be forced axially so as to break any remaining connection therebetween. Once broken, the remaining portions can be readily removed radially relative to casing 110.

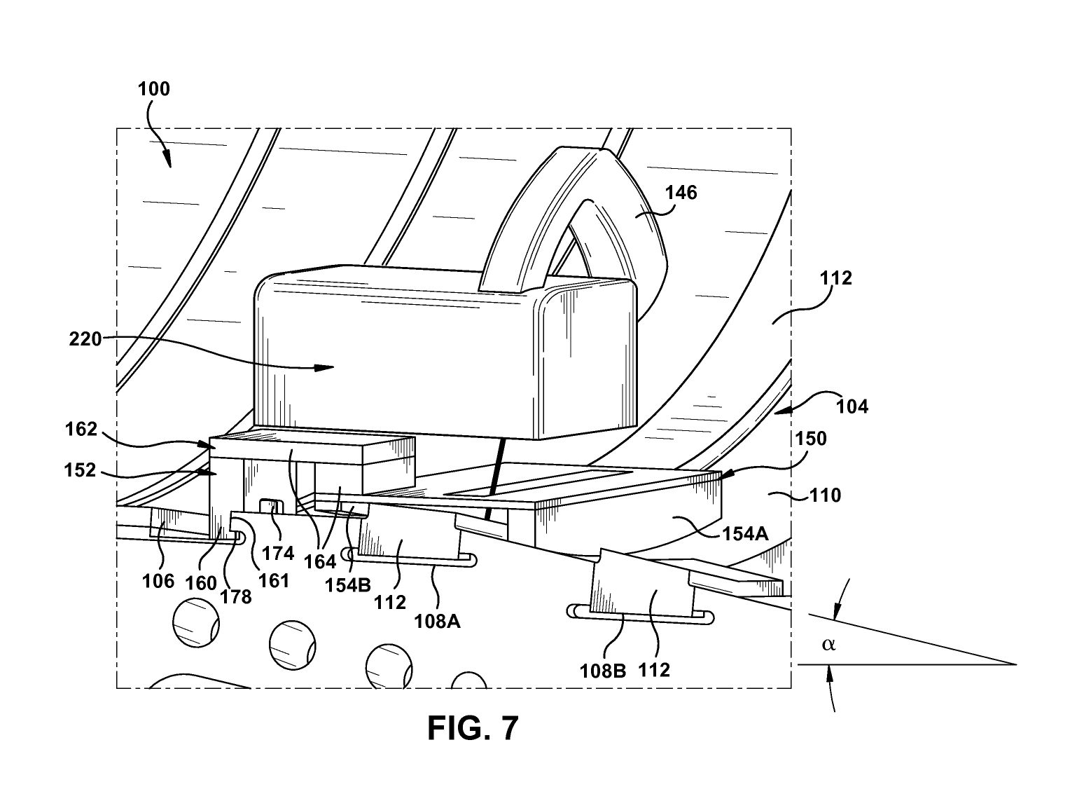

While slide member 160 and incline compensating members 154 have been described herein as sliding surfaces, it is emphasized that each member can be readily replaced with other elements that allow linear movement of cutting tool 120 relative to casing 100. For example, members 160, 154 could include roller bearings or cat tracks, rather than surfaces in contact with casing 100. In addition, guide 150 has been described herein as being employed with a cutting tool 120 in the form of a circular saw. It is emphasized that guide 150 could also be employed with other cutting systems. For example, as shown in FIG. 7, guide 150 could be employed with a cutting tool 220 in the form of, for example, grinding wheel, cutting torch, arc gouging electrode, laser cutting tool, or any other form of linear cutting system for metal that can be positioned using guide 150.

Cutting tool 120, 220 and/or guide 150 for use with a cutting tool provide an alternative to arc gouging out ring segments if they have become seized in a turbomachine casing, thus saving time and costs. In addition, since cutting tool 120, 220 with guide 150 safely and quickly cuts ring segment 112, the tool is safer than conventional techniques. Cutting tool 120 is also easy to set up and is implemented manually without a complicated mounting bridge or automated propulsion system.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A cutting tool for cutting a blade mount ring segment from a ring segment slot in a turbomachine casing having a plurality of ring segment slots along an inclined surface, the cutting tool comprising:
a motor;
a cutting blade driven by the motor to cut the ring segment;
a support element for supporting the motor;
a guide for guiding the tool circumferentially relative to the ring segment, the guide including:
a rip fence extending from the support element and including a slide member for slidingly engaging a respective empty ring slot that is axially displaced in the turbomachine casing from the slot in which the ring segment is positioned, and
at least one incline compensating member coupled to the support element for slidingly engaging the inclined surface of the turbomachine casing and positioning the support element such that the cutting blade cuts the ring segment.

2. The cutting tool of claim 1, wherein the at least one incline compensating member includes a pair of incline compensating members, one to each side of the cutting blade and each slidingly engaging a different portion of the internal surface.

3. The cutting tool of claim 2, wherein each incline compensating member extends a different distance from the support element to slidingly engage the internal surface.

4. The cutting tool of claim 1, wherein each incline compensating member includes a curved casing engaging surface configured to substantially mate with a circumferential arc of the internal surface of the turbomachine casing.

5. The cutting tool of claim 4, wherein the curved casing engaging surface also includes an axial bevel configured to substantially mate with an axial internal angle of the inclined surface of the turbomachine casing.

6. The cutting tool of claim 1, wherein each incline compensating member includes an axial bevel configured to substantially mate with an axial internal angle of the inclined surface of the turbomachine casing.

7. The cutting tool of claim 1, wherein the cutting blade extends through an opening in the support element, and further comprising a cutting depth adjuster for selectively controlling an extent to which the cutting blade extends from the support element.

8. The cutting tool of claim 1, wherein the rip fence further includes an adjustable arm supporting the slide member.

9. The cutting tool of claim 1, wherein the slide member includes a curved casing engaging surface configured to substantially mate with a circumferential arc of the internal surface of the turbomachine casing in the empty ring slot.

10. The cutting tool of claim 1, wherein the slide member includes a roller bearing for rollingly engaging an axially facing surface of the empty ring slot.

11. The cutting tool of claim 1, wherein the slide member further includes a retaining member engaging a circumferential groove in the empty ring slot to slidingly retain the slide member in the empty ring slot.

12. A guide for circumferentially guiding a cutting tool for cutting a blade mount ring segment from a ring segment slot in a turbomachine casing having a plurality of ring segment slots along an inclined surface, the cutting tool including a support element for supporting a cutting element of the cutting tool, the guide including:
a rip fence extending from the support element and including a slide member for slidingly engaging a respective empty ring slot that is axially displaced in the turbomachine casing from the slot in which the ring segment is positioned; and
at least one incline compensating member coupled to the support element for slidingly engaging the inclined surface of the turbomachine casing and positioning the support element such that the cutting element cuts the ring segment.

13. The guide of claim 12, wherein the at least one incline compensating member includes a pair of incline compensating members, one to each side of the cutting element and each slidingly engaging a different portion of the internal surface.

14. The guide of claim 12, wherein each incline compensation member extends a different distance from the support element to slidingly engage the internal surface.

15. The guide of claim 12, wherein each incline compensating member includes a curved casing engaging surface configured to substantially mate with a circumferential arc of the internal surface of the turbomachine casing.

16. The guide of claim 12, wherein each incline compensating member includes an axial bevel configured to substantially mate with an axial internal angle of the inclined surface of the turbomachine casing.

17. The guide of claim 12, wherein the cutting element extends through an opening in the support element, and further comprising a cutting depth adjuster for selectively controlling an extent to which the cutting element extends from the support element.

18. The guide of claim 12, wherein the slide member includes a curved casing engaging surface configured to substantially mate with a circumferential arc of the internal surface of the turbomachine casing in the empty ring slot.

19. The guide of claim 12, wherein the slide member includes a roller bearing for rollingly engaging an axially facing surface of the empty ring slot.

20. The guide of claim 13, wherein the slide member further includes a retaining member engaging a circumferential groove in the empty ring slot to slidingly retain the slide member in the empty ring slot.
